(19) United States
(12) Patent Application Publication
(10) Pub. No.: US 2024/0338369 A1
(43) Pub. Date: Oct. 10, 2024

(54) METHOD AND SYSTEM FOR PROVIDING DATA ACCESS SERVICE

(71) Applicant: Keyi Wang, Chino Hills, CA (US)

(72) Inventor: Keyi Wang, Chino Hills, CA (US)

(21) Appl. No.: 18/297,622

(22) Filed: Apr. 9, 2023

(51) Int. Cl. G06F 16/2455; G06F 16/2453

(52) U.S. Cl. CPC G06F 16/2455; G06F 16/24542

(57) ABSTRACT

Method for providing data access service to a database comprises executing a service specification using a service engine, wherein the service specification is independent of programming languages and is composed declaratively using SQL and JSON, preferably. Examples are provided for common data access service types, including query service, SQL service, PROC service and CRUD service for relational database. Method is disclosed for designing service specifications for less common type of databases and data access patterns. A service engine can be implemented for executing a particular type of data access service. A collection of service engines and of service specifications can be built and hosted on a server for providing full data access services to client application.

### CROSS-REFERENCE TO RELATED APPLICATIONS

This application claims the benefit of provisional application No. 63/334,345, filed on Apr. 25, 2022. The provisional application relates method and system for providing data access service. The present application is a continuation of the subject matter disclosed in the provisional application.

### STATEMENT REGARDING FEDERALLY SPONSORED RESEARCH OR DEVELOPMENT

Not applicable.

### TECHNICAL FIELD

The present disclosure is related to database access in general and systems and methods for providing data access services in specific.

### BACKGROUND OF THE INVENTION

Database application typically includes in its architecture a data access layer composed of data access objects (DAO) and/or repository objects to abstract away the database and database access details from the application layer. However, inside the DAO and repository objects, the developer still need to code the details of retrieving and saving objects in the database. Data access coding is tedious when the object and query are simple, but hard when the object and query are complex, especially when the database is relational, due to so called object-relational-impedance-mismatch problem.

Various technologies have been developed to alleviate this issue, including JDBC template, JOOQ (Java Object-Oriented Query) and ORM (Object-Relational Mapping) for Java and similar technologies for other programming languages. However, JBDC template, using raw SQL, and JOOQ, being a query builder, only help in a limited extent. ORM works well for CRUD operations of relatively simple objects, but fails for complex objects and queries. In addition, ORM adds its own complexity to the problem, and ties the database data model to the application data model. In short, the existing data access solutions are far from satisfactory.

In all prior arts, the data access logic is coded with an imperative programming language, which is the root cause for the paradigm mismatch and the complexity of coding data access logic. On the other hand, however, data access logic follows a handful of simple patterns. One is query, which takes a few input parameters, returns one object as output, and is normally done by one, sometimes more, select statements. Another one is command, which takes some data input, saves or otherwise modifies data in the database, and is normally implemented with one or more DML (data manipulation language) statements, or with a stored procedure. Yet another one is repository, which deals with the CRUD (create, read, update and delete) operation of aggregate objects. It is possible to abstract these common data access patterns into data access services, standardize them, and specify them declaratively with pure database statements and objects, independent of programming languages, and thus simplify database programming.

Furthermore, as the application is increasingly cloud-native, data access service is a great way to provide database access as a backing service and abstract database away from the application.

### BRIEF SUMMARY OF THE INVENTION

The present invention discloses a method for providing data access services using service specification and service engine. The service specification is a declarative specification of a data access service. The service engine is an execution engine for executing the service specification.

The present invention discloses the general structure of the service specification and the general steps that the service engine follows to perform a service operation. The two distinct features of the service specification include: a) it uses JSON or other platform-independent object notion for specifying the input and output of a data access service; and b) it uses native database commands and objects for specifying what action(s) needs to be done against the database by a service operation, but not how it is done. Different from all existing data access methods, database commands are no longer embedded or executed in a host programming language, such as Java.

The exact components of service specification and the exact steps of executing it vary with the type of data access services. The present invention provides examples of four concrete types of data access services, namely query, SQL, PROC and CRUD, and discloses the methods for executing each of these four types of data access services by the service engine. The present invention also discloses a method for designing a new specification type for a new data access service type, and the general steps for executing a data access service by the service engine.

The present invention further discloses a system for providing data access services, comprising a plurality of service specifications and a plurality of service engines. It also discloses the steps the system follows to serve data access requests.

The present invention provides a better abstraction of the database and data access logic, and a simple, language-independent, declarative way of building the data access logic, by standardizing the common data access patterns and the data access service specifications.

### BRIEF DESCRIPTION OF THE SEVERAL VIEWS OF THE DRAWINGS

FIG. 1 illustrates a block diagram of a generic data access service specification.

FIG. 2 illustrates an exemplar query service specification.

FIG. 3 illustrates an exemplar SQL service specification.

FIG. 4 illustrates an exemplar PROC service specification.

FIG. 5 illustrates an exemplar CRUD service specification.

FIG. 6 illustrates the READ components of the exemplar CRUD service specification.

FIG. 7 illustrates the WRITE components of the exemplar CRUD service specification.

FIG. 8 illustrates the generic operation of a data access service engine.

FIG. 9 illustrates the general steps that a data access service engine follows to perform a data access service operation.

FIG. 10 illustrates the steps that the query service engine follows to perform a query service.

FIG. 11 illustrates the steps that the SQL service engine follows to perform a SQL command service.

FIG. 12 illustrates the steps that the PROC service engine follows to execute a PROC command service.

FIG. 13 illustrates the steps that the CRUD service engine follows to perform a create operation.

FIG. 14 illustrates a block diagram of a method for designing a specification type for a desired service type.

FIG. 15 illustrates a block diagram of a system for providing data access service.

### DETAILED DESCRIPTION OF THE INVENTION

### Service Specification

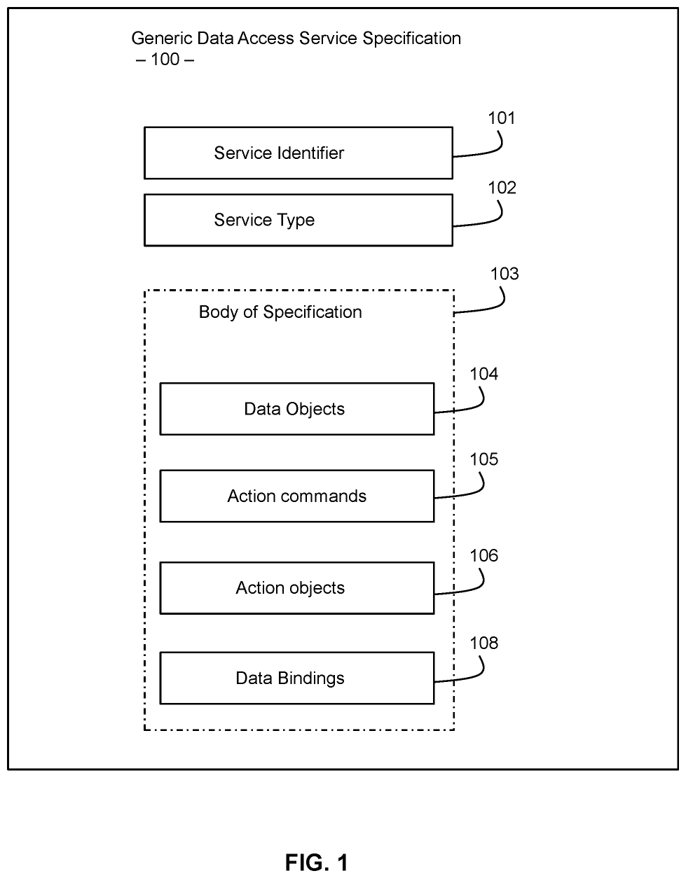

FIG. 1 illustrates a block diagram of a generic data access service specification (or service specification) according to one embodiment of the current invention. The service specification 100 comprises
A service identifier 101
A service type element 102
A body of specification 103 that comprises a combination of
   Data objects 104
   Action commands 105
   Action objects 106, and
   Data bindings 108

The service specification 100 specifies an instance of data access service. The data access service is a set of operations that may be invoked against a database, for example, a query operation to query or retrieve data from the database, a command operation to create, delete, or otherwise change the data in the database, or an operation combining manipulation and query of data. For data access service of single operation, a query service for example, the service and operation are not distinguished.

The service identifier 101 is a name, qualified or not qualified, an uri (universal resource identifier) or other means uniquely identifying the service.

The service type 102 specifies the type of the data access service. It implicitly defines:
The set of operations supported by the service
The structure of the body of specification 103, and
The input, output and the action(s) to be carried out against the database for each operation

The service type 102 also defines an implicit contract between the service specification and the service engine for executing the service specification.

The body of specification 103 varies with the service type, but is generally a combination of
Data objects 104 specifying the input(s) and output(s) of the service operation(s)
Action commands 105, such as SQL statements, procedure calls, DB scripts, etc., specifying the database commands to run against the database
Action objects 106, such as database tables, stored procedures, etc., specifying the targets of database operations, and
Data bindings 108 that maps the fields of input data objects 104 to the parameters and/or fields of the action command 105 and/or action objects 106, and the fields of output data objects 104 to the results and/or fields of the action commands 105 and/or action objects 106.

The exact components of the body of the specification are decided by the design of the service type. The body of specification 103 is further illustrated by the concrete service types disclosed below in the current invention.

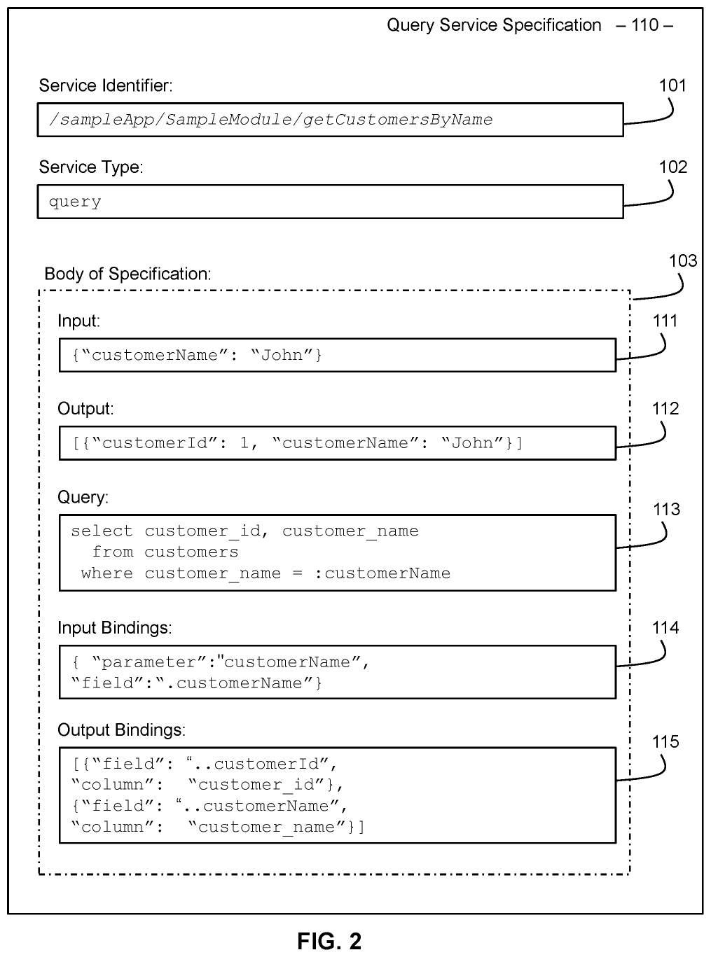

FIG. 2 illustrates an exemplar query service specification (or query specification) according to one embodiment of the present invention. The query specification 110 specifies a query service for retrieving data from the database using a native database query. It comprises
A service identifier 101
A service type 102 indicating a query service
A body of specification 103 that comprises
   An input component 111 specifying the input object expected by the service
   An output component 112 specifying the output object returned by the service
   A query component 113 specifying the query statement to be executed against the database
   An input binding component 114 mapping the input data fields to the query parameters
   An output binding component 115 mapping the output data fields to the query columns.

The query service supports a single query operation to retrieve data from the database. The exemplar query service is to retrieve an array of customer objects by a customer name. The input is a simple object with a customerName field specified with JSON string. The output is an array of customer objects specified with JSON string. The action command is a single SQL query to retrieve the customer data. The query parameters are mapped to the input fields by the input bindings 114, and the query result is mapped to the output fields by the output mappings 115. The data bindings 114 and 115 are also specified with JSON strings.

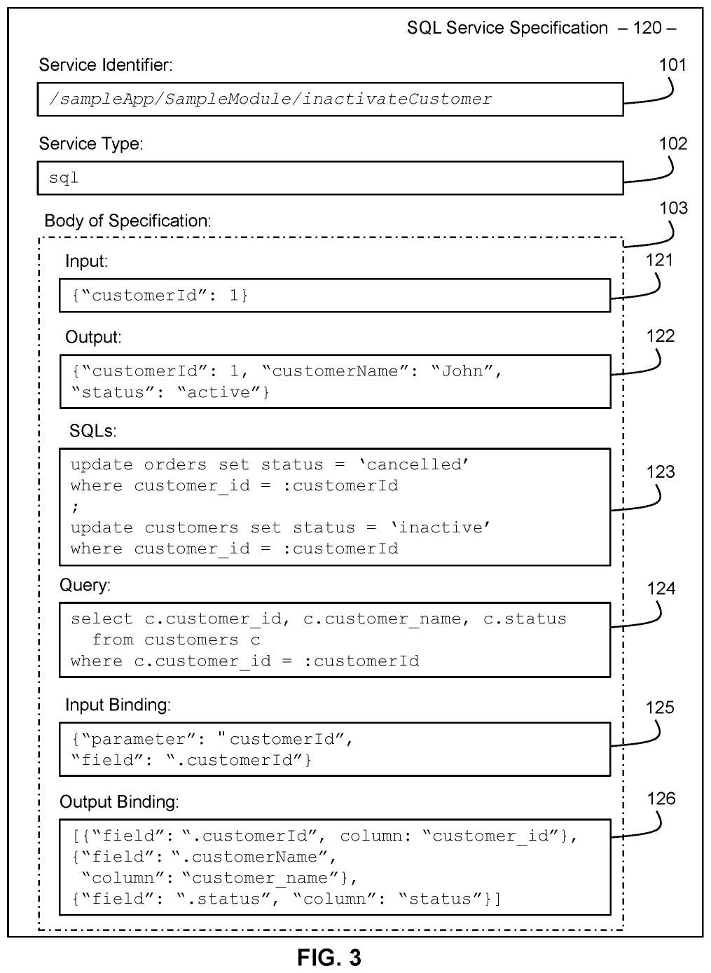

FIG. 3 illustrates an exemplar SQL service specification (or SQL specification) according to one embodiment of the present invention. The SQL specification 120 specifies a command service for manipulating data in the database using a set of native database DML (data manipulation language) statements. It comprises
A service identifier 101
A service type 102 indicating a SQL service
A body of specification 103 that comprises
   An input component 121 specifying the input object expected by the service
   An output component 122 specifying the output object returned by the service
   A SQLs component 123 specifying the DML statement(s) to be executed against the database
   A query component 124 specifying the query statement to be executed against the database after the SQLs
   An input binding component 125 mapping the input data fields to the parameters of the SQL statements and the query statement
   An output binding component 126 mapping the output data fields to the query columns

The SQL service is a command service supporting a single operation to modify the data in the database. The exemplar SQL service is to inactivate a customer and cancel all purchase orders by the customer, and then return the updated customer object. The input 121 is a simple object with a customerId field. The output 122 is a customer object. The action commands are two SQL update statements 123 followed by a SQL query 124. The input fields are mapped to the SQL and query parameters by the input bindings 125, and the output fields are mapped to the query result by the output bindings 126.

The SQL service has multiple action commands, SQLs 123 and query 124, with the query 124 being optional. If the query is not specified, the output and output bindings are not needed. In this case, only the SQLs 123 will be executed and the output of the service will be null by design of the SQL service.

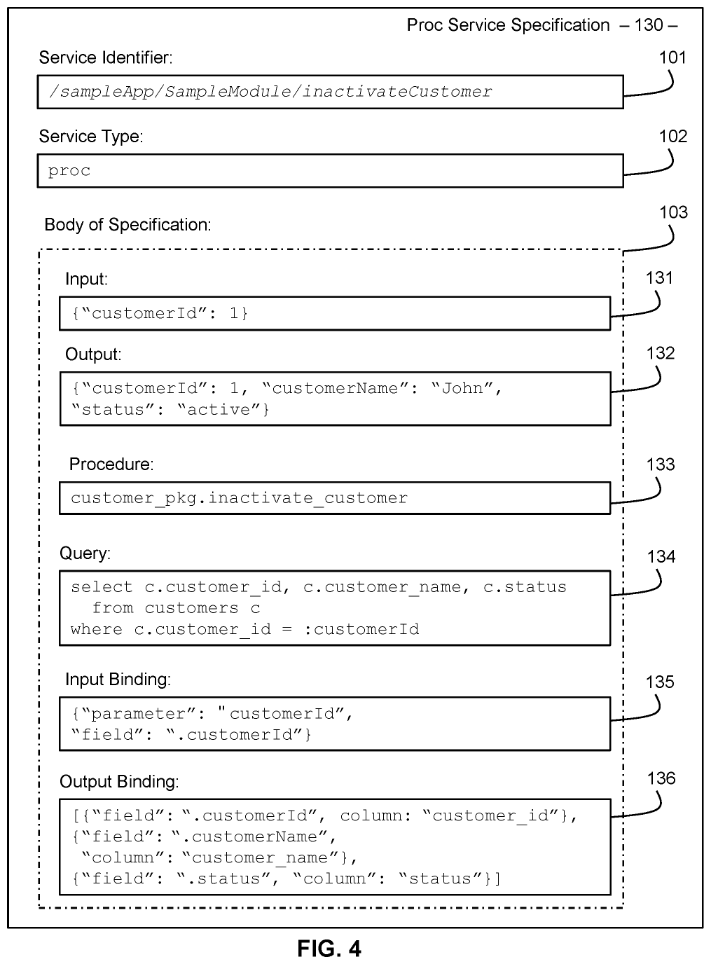

FIG. 4 illustrates an exemplar PROC service specification (or PROC specification) according to one embodiment of the present invention. The PROC specification 130 specifies is another command service for modifying the data in the database by executing a stored procedure in the database. It comprises
A service identifier 101
A service type 102 indicating a PROC service
A body of specification 103 that comprises
   An input component 131 specifying the input object expected by the service
   An output component 132 specifying the output object returned by the service
   A procedure component 133 specifying the name of the stored procedure to be executed
   A query component 134 specifying the query statement to be executed against the database after the procedure
   An input binding component 135 mapping the input data fields to the parameters of the procedure and the query statement
   An output binding component 136 mapping the output data fields to the query columns

The PROC service supports a single operation to execute a stored procedure. The exemplar PROC service is to inactivate a customer through a stored procedure and return the updated customer data. The input and output are the same as the exemplar SQL service, but the SQLs 123 is replaced with a stored procedure 133 to be executed by the service. The procedure parameter is mapped to the input field by the input bindings 135, and the result of the query is mapped to the output field by the output bindings 136.

Like the SQL service, the query 134 in the PROC specification 130 is also optional.

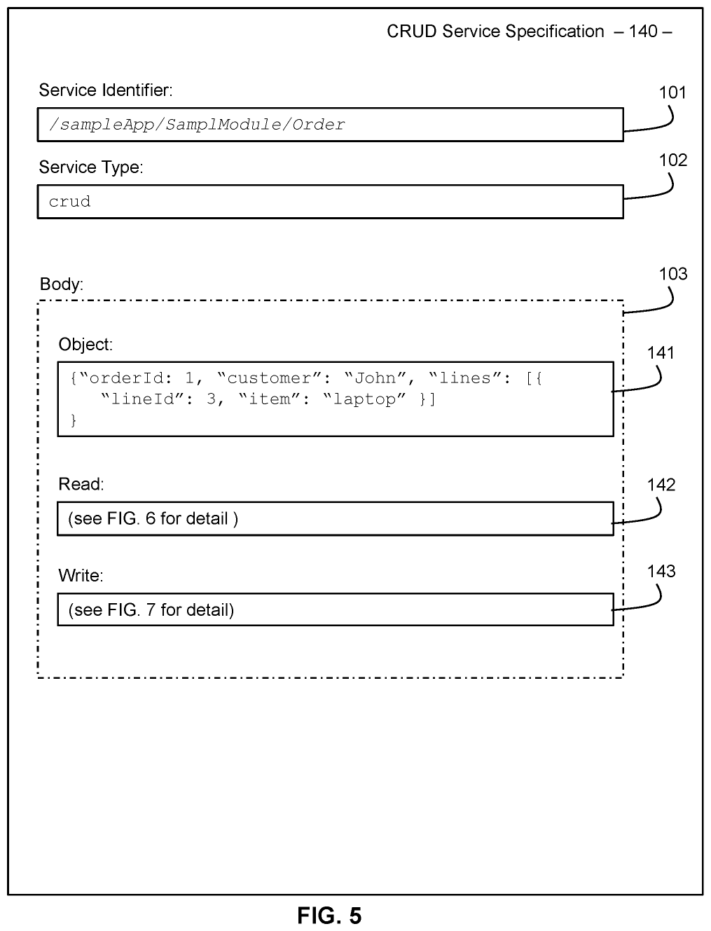

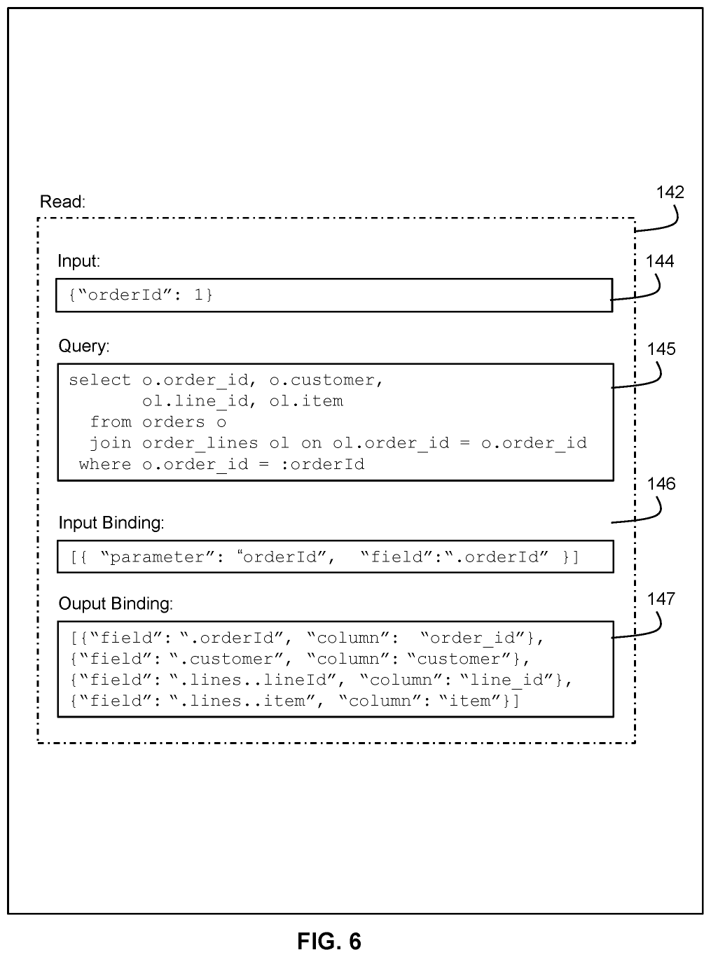

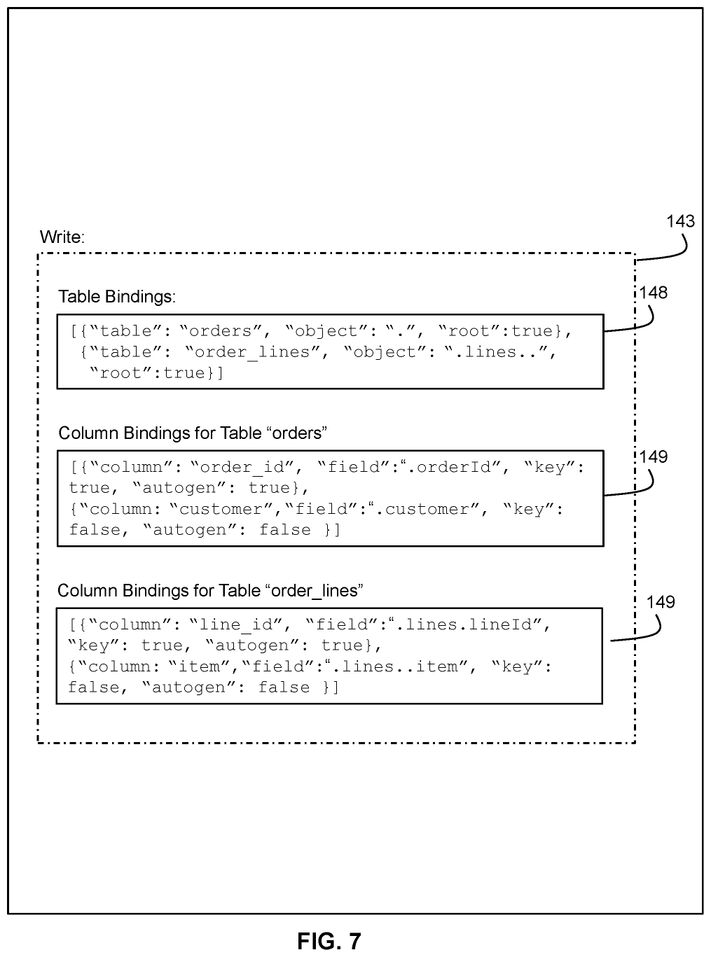

FIG. 5 illustrates an exemplar CRUD service specification (or CRUD specification) according to one embodiment of the present invention. FIG. 6 illustrates the read component of the exemplar CRUD service. FIG. 7 illustrates the write component of the exemplar CRUD service.

The CRUD specification 140 specifies a CRUD service for reading, creating, updating and deleting an aggregate object in the database. It comprises
A service identifier 101
A service type 102 indicating a CRUD service
A body of specification 103 that comprises
   An object component 141 specifying the structure of the object operated by the service
   A read component 142 specifying the logic of the read operation (read)
   A write component 143 specifying the logic of the write operations (create, update and delete)

The read component 142 comprises
An input subcomponent 144 specifying the input object expected by the read operation
A query subcomponent 145 specifying the query statement to be executed against the database for the read operation
An input binding subcomponent 146 mapping the input data fields to the query parameters
An output binding subcomponent 147 mapping the object data fields to the query columns.

The write component 143 comprises
A table bindings subcomponent 148 mapping the object and its child structures to database tables, and
Column bindings subcomponents 149 mapping the object fields to columns of the tables

The CRUD service is multi-operation service, supporting the CREATE, READ, UPDATE and DELETE operations of an aggregate object. The exemplar CRUD service is for reading, creating, deleting and updating a purchase order object (the ORDER object) stored in database tables ORDERS and ORDER_LINES.

The object 141 component specifies the structure of the ORDER object, which is both the output of the READ operation and the input of the CREATE, UPDATE and DELETE operations.

The read 142 component specifies the input 144 and the query 145 for the read operation, which is basically a query service. The output of the read operation is an array of ORDER objects by the design of CRUD service. The input bindings 146 map the input fields to the query parameters; the output bindings 147 map the object fields to the query results.

The write 143 component specifies the tables to insert, update and delete, as well as the source of data for the CREATE, UPDATE and DELETE operations, with the table bindings 148 and column bindings 149. The table bindings 148 map the object and its child structure to database tables. For the exemplar CRUD service, the ORDER object is mapped to the ORDERS table, and the LINES array structure inside the ORDER object to the ORDER_LINES table. The column bindings 149 map the object fields to the columns of the ORDERS and ORDER_LINES tables, respectively, and provide information such as whether a column is a key column and whether it is an auto-generated column for insert. There is a column binding component 149 for each table. The CRUD service engine generates the right SQL statements based on these bindings.

The input of the CREATE, UPDATE and DELETE operations is a single or an array of the objects. The output of the CREATE and UPDATED is a single or an array of the objects created or updated by the operation; the output of the DELETE operation is NULL by definition according to one embody of the present invention.

In the examples in FIG. 2-7, the structure of the data objects (input, output and object) are all specified with sample JSONs. However, it may also be specified with other object notions, such as JSON schema. XML, YMAL, etc.

The examples in FIG. 2-7 are all given for relational or SQL databases. However, similar data access service types may be easily created for other types of database. For example, a document query service may be created for a document database by changing the query component from a SQL query to a document query.

For illustration purpose, the components of the exemplar service specifications in FIG. 2-7 are all specified on one sheet of paper. In actually implementation, the different components of a service specification may be distributed in separate files, database tables or storages, and assembled into one whole specification when needed.

Further, the four concrete types of data access services are given for teaching purpose. For a person skilled in the art, it is not difficult to recognize other data access service patterns and design a new service type in the same spirit as illustrated by the examples.

A distinct feature of the service specification 100 is that it is platform independent or it does not depend on any application programming language, and as a result the developer does not have to perform data access or SQL development within a host language, which is the source of the paradigm mismatch issue and the complexity of existing data access development methods.

### Service Engine

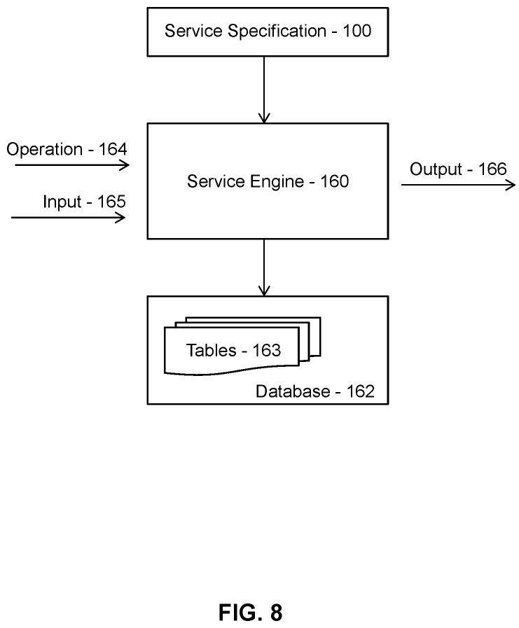

The service specification is executed by the service engine. FIG. 8 illustrates the operation of a generic service engine 160 according to one embodiment of the current invention, comprising
a. A service operation is invoked by feeding the service specification 100, operation to perform 164 and input for the operation 165 to the service engine 160, and
b. The service engine 160 performs the actions embodied in the operation according to the service specification against the database 162, and produces the output for the operation 166.

Alternatively, the service specification 100 is pre-fed to the service engine 160 and a service operation is invoked by feeding the operation to perform 164 and the input for the operation 165 to the service engine 160.

A super service engine may be implemented to execute service specifications of all data access service types. However, the preferred embody of the current invention is implementing a specialized service engine per service type. Thus the query service is handled by the query service engine; the SQL service is handled by the SQL service engine; the PROC service is handled by the PROC service engine; and the CRUD service is handled by the CRUD service engine, etc. This simplifies the design of the individual service engine.

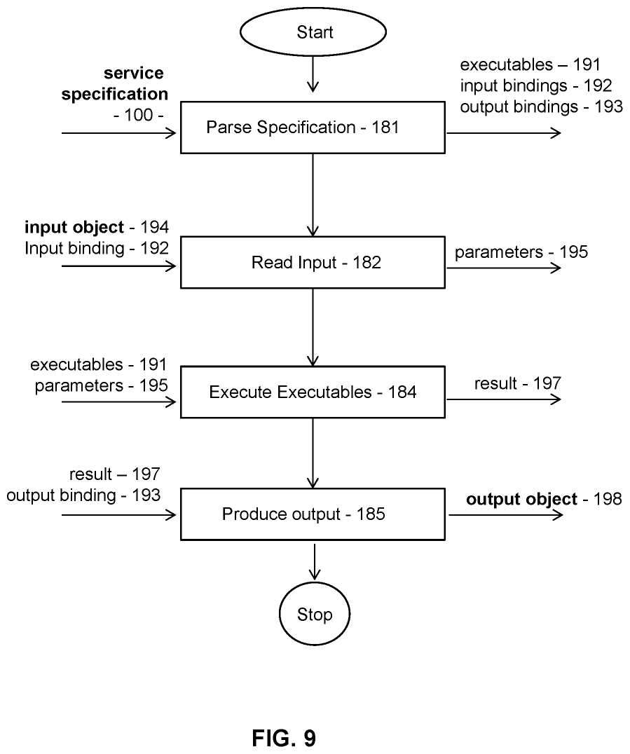

FIG. 9 illustrates the general steps that a service engine follows to perform a service operation, comprising
a. Parsing Specification 181, where the service specification 100 is parsed to yield the executables 191, the input bindings 192, and the output bindings 193 that are relevant to the operation. The executables 191 can be the action commands 105 or action objects 106, depending on the service type and the operation;
b. Reading Input 182, where the input object 194 is read with the help of the input binding 192 to yield the parameters for the executables 195;
c. Executing Executables 184, where the executables 191 are executed with the parameters 195, according to the way implied by the service operation, to yield a result 197; and
d. Produce output 185, where the result 197 is transformed with the help of the output bindings 193 into a structured output object 198.

The exact steps that service engine follows vary with the type of the data access service and the operations it performs. Given a concrete service type and service operation, however, the above steps can be developed by a person skilled in the art without much difficulty for the service type and operation, as illustrated in the following with the query, SQL, PROC and CRUD services.

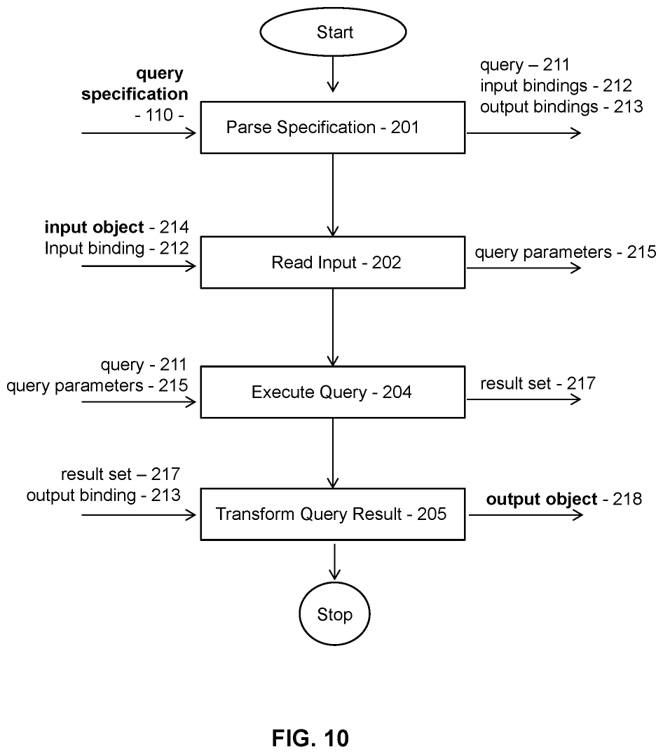

Given a query specification 110 and an input object 214, FIG. 10 illustrates the steps that the query service engine follows to perform the query service according to one embodiment of the present invention, comprising
a. Parsing Specification 201, where the query specification 110 is parsed to yield the query statement 211, the input bindings 212, and the output bindings 213;
b. Reading Input 202, where the input object 214 is read with the help of input binding 212 to yield query parameters 215. Input binding 212 specifies the data field(s) of Input 211 to read;
c. Executing Query 204, where the query statement 211 is executed with the query parameters 215 to yield a result set 217; and
d. Transforming Query Result 205, where the result set 217 is transformed with the help of output bindings 213 into a structured output object 218.

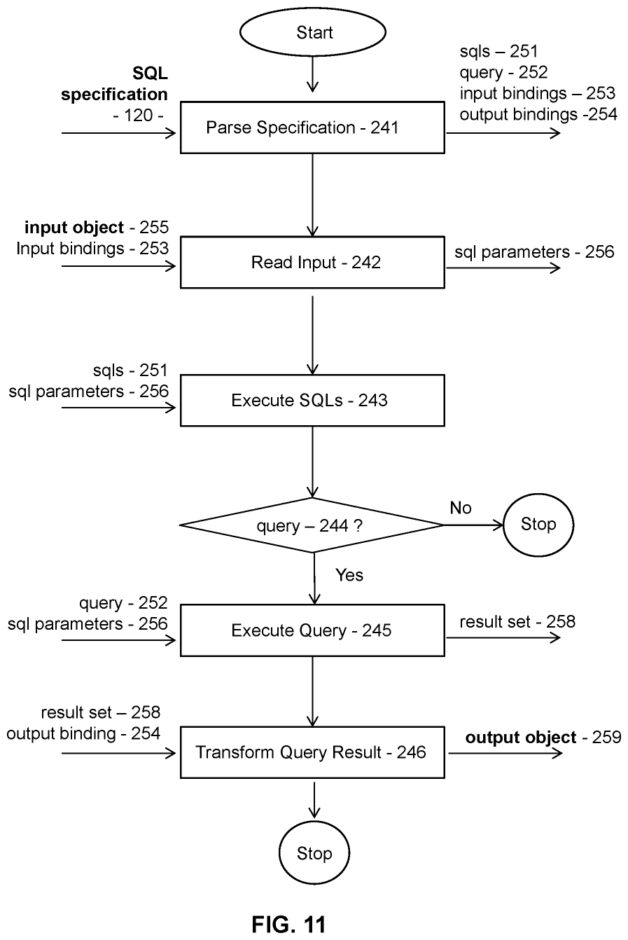

Given a SQL specification 120 and an input object 255, FIG. 11 illustrates the steps that the SQL service engine follows to perform the SQL service according to one embodiment of the present invention, comprising
a. Parsing Instruction 241, where the SQL specification 120 is parsed to yield the SQL statements 251, the query 252 (if specified), the inputs binding 253, and the output bindings 254 (if specified);
b. Reading Input 242, where the input object 255 is read with the help of the input binding 253 to yield the SQL parameters 256;
c. Executing SQLs 243, where the SQL statements 251 are executed with SQL parameters 256, one by one;
d. Check Query 244, stop and return null if not present; continue otherwise;
e. Executing Query 245, where the query statement 252 is executed with the SQL parameters 256 to yield a result set 258; and
f. Transforming Query Result 246, where the result set 258 is transformed with the help of the output bindings 254 into a structured output object 259.

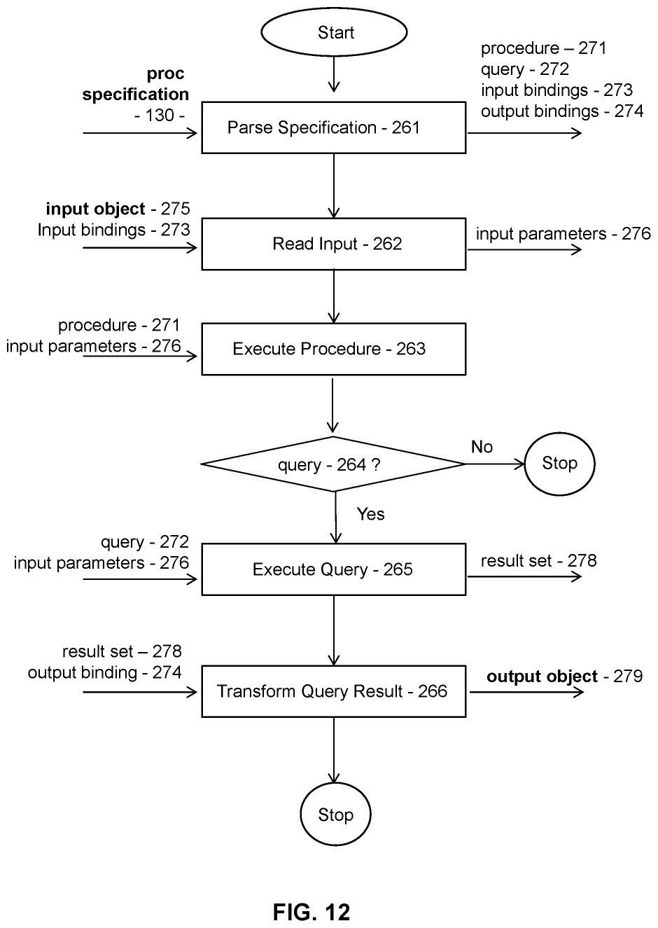

Given a PROC specification 130 and an input object 275, FIG. 12 illustrates the steps that the PROC service engine follows to perform the PROC service according to one embodiment of the present invention, comprising
a. Parsing Specification 261, where the PROC specification 130 is parsed to yield the procedure 271, the query 272 (if specified), the input binding 273, and the output binding 274 (if specified);
b. Reading Input 262, where the input object 275 is read with the help of the input binding 273 to yield the input parameters 276;
c. Executing Procedure 263, where the procedure 271 is executed with the input parameters 276;
d. Check Query 264, stop and return null if not present; continue otherwise;
e. Executing Query 265, where the query statement 272 is executed with the input parameters 276 to yield a result set 278; and
f. Transforming Query Result 266, where the result set 278 is transformed with the help of the output bindings 274 into a structured output object 279.

Unlike the query, SQL and PROC services, the CRUD service is a multi-operation service. The CRUD service engine must be able to perform READ, CREATE, UPDATE and DELETE operations. The READ operation is basically a query service, and therefore the steps are similar to those for the query service. The steps for the CREATE, UPDATE and DELETE operations are similar. For brevity, only the steps for the CREATE operation is illustrated below for teaching purpose. The steps for UPDATE and DELETE can be easily developed by a person skilled in the art with the help of the example of the CREATE operation.

Given a CRUD specification 140 and an input object 295, FIG. 12 illustrates the steps that the CRUD service engine follows to perform the CREATE operation of the CRUD service according to one embodiment of the present invention, comprising
a. Parsing Specification 281, where the write component of the CRUD specification 140 is parsed to yield the table bindings 293 and column bindings 294;
b. Read Tables 282, where the table bindings 293 is processed to yield the list of tables 291 to insert records;

For each table,
c. Reading Input 283, where the input object 295 is read with the help of the table binding 293 to yield data object(s) 296 to be saved in the table;
d. Reading Columns 284, where the data object(s) 296 is read with the help of the column binding 294 to yield the columns 292 and column values 297;
e. Creating SQL 285, where the table 291, the columns 292 and column values 297 are used to create SQL insert statement(s) 298;
f. Executing SQL 286, where the SQL statement 298 is executed and the key 298 for the inserted record is returned;

Then,
g. Re-querying Object 287, where a read operation is performed with the key 298 for the root table to get the new object as output 299.

### Method and System

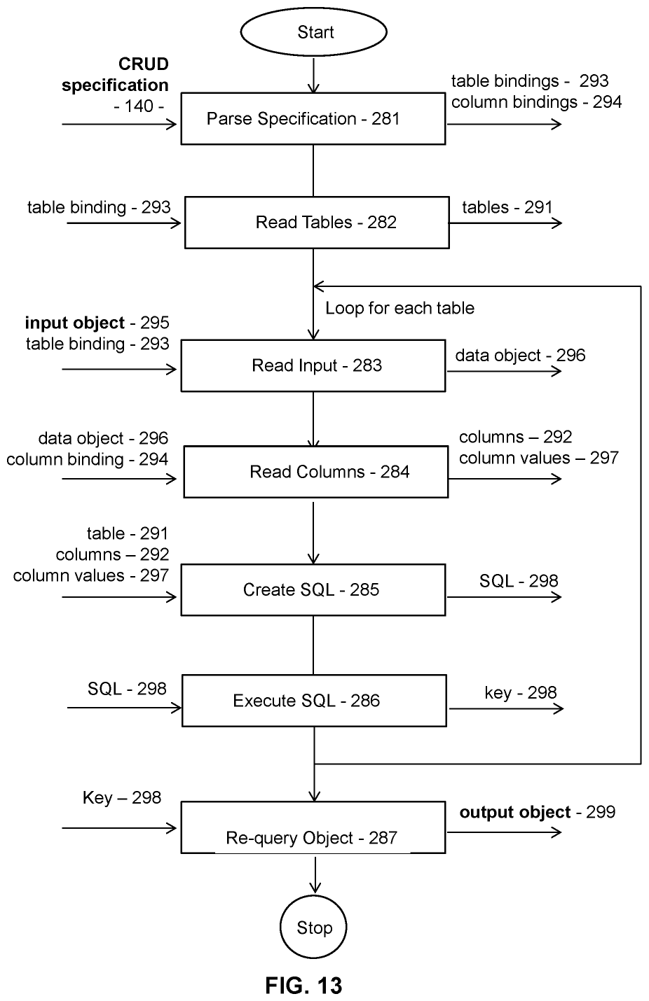

In previous section, FIGS. 8 and 9 disclose a general method for providing data access service by executing a service specification using service engine. FIG. 10-14 disclose methods for providing query service, SQL service, PROC service and CRUD service against a relational database by executing query specification, SQL specification, PROC specification and CRUD specification using query engine, SQL engine, PROC engine and CRUD engine, respectively.

To provide data access service beyond the query, SQL, PROC and CRUD services, or data access service against a different type of databases, one would need to design a new service specification type (or specification type) for the new type of data services and to implement a new service engine for executing the said specification type for the said type of data services, so that user can create a service specification of the said specification type and executing it with the said service engine.

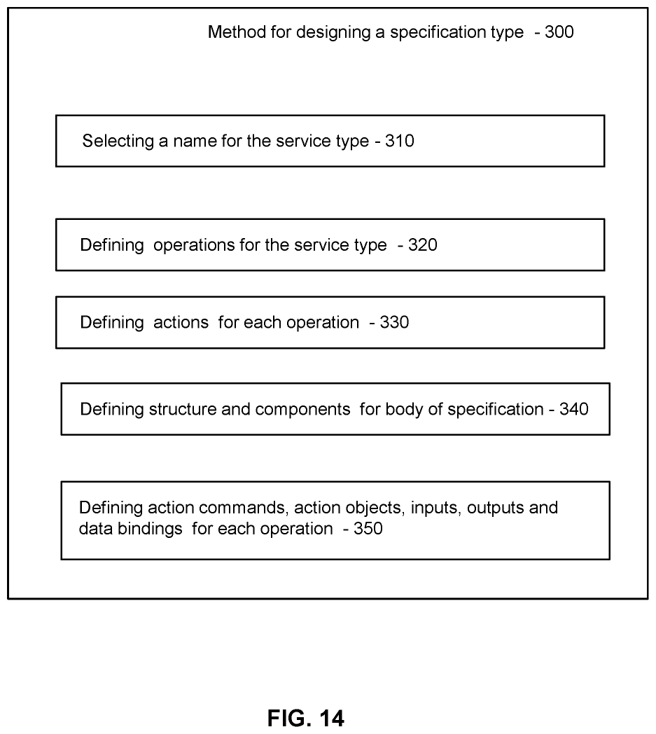

FIG. 14 illustrates a block diagram of a method for designing a specification type 300 for a desired service type according to one embodiment of the present invention, comprising
a. Selecting a name for said service type 310
b. Defining a set of operations for said service type 320
c. Defining a set of actions against the database for each said operation 330
d. Defining a structure and a set of components for the body of specification 340, comprising required and optional data objects, action commands, action objects and/or data bindings, and
e. Defining the set of the input, output, action commands, action objects, input bindings and output bindings for each said operation 350

The requirements, especially the set of operations and the actions for each operation, for the service type shall be based on a distinct data access pattern. The concrete query, SQL, PROC and CRUD services can serve as examples of said method for designing new data access service and specification type.

The service engine for the said service type can be implemented according to the general steps outlined in FIG. 9. The concrete query, SQL, PROC and CRUD engines can serve as examples for implementing the said service engine for the said service type, according to FIG. 9.

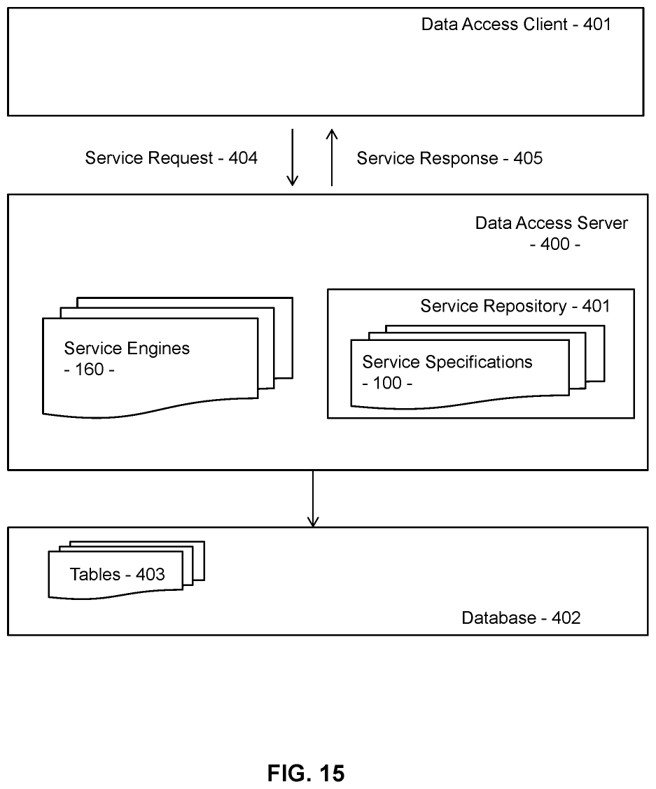

FIG. 15 illustrates a block diagram of a system for providing data access service according to one embodiment of the present invention. The system comprises a data access client 401, a data access server 400, and a database 402. The data access server 400 comprises a set of service engines 160 and a service repository 401 holding a set of service specifications 100. The set of service specifications 100 may be of various service types. There is one service engine 160 for each of the service types the server 400 supports. The service repository 401 can be any means that holds the service specifications for the server 400. If the specifications are manifested as files, the service repository may be a file structure to store the files.

To invoke a data access service, the data access client 401 sends a service request 404 to the data access server 400. The service request 404 includes
The service identifier of the data access service to invoke
The operation to perform against the database; and
The input for the service operation.

The data access server 400
receives the service request 404
locates the service specification 100 with the service identifier
finds out the service type from the service specification 100
selects the service engine 160 for the service type
feeds the service specification 100, the requested operation and the service input to the service engine 160

The service engine 160
Performs the requested operation against the database 402 according to the service specification 100.
Returns the service output to the data access server 400

The data access server 400
creates a service response 405 with the service output, and returns it to the data access client 401

The data access client 401 is normally a client application, but can be anything that needs to access the database 402. The data access server 400 can be a stand-alone server, a cloud platform or embedded in an application or database.

The service engine and service system disclosed in the current invention may be implemented in any programming languages, for any platforms and devices, including the various languages for database stored procedures. The service specification disclosed in the current invention may be manifested in many forms without departing from the spirit or characteristics of the present invention. For example, it may be created as one single text file of JSON or YMAL; or it may be split into multiple JSON and SQL files, with each component included in a file of proper type; or it may be stored as one or more database records; or it may be even specified with an artifact associated with a particular programming language, a Groovy object and/or DSL (domain specific language) for example, if doing so provides advantages or benefits. The service identifier may be manifested as a text string in a file, or the name of a file or folder, a url or uri, or any other means that uniquely identifies an instance of data access specification. The service type may be specified together with the body of the specification, or separated from the body of specification as part of service meta data, or implicitly by the components that goes into the body of the specification or other means.

The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B. The term “comprising” as used in the claims does not exclude other elements or steps. The term “a combination of” as used in the claims does not exclude other elements that are not explicitly listed. The term “a” or “an” as used in the claims does not exclude a plurality. The term “plurality” as used in the claims does not exclude a single unit. A unit or other means may fulfil the functions of several units or means recited in the claims.

1. A service specification for specifying a data access service.

2. A service specification according to claim 1, wherein said service specification is a query specification specifying a query service.

3. A service specification according to claim 1, wherein said service specification is a SQL specification specifying a SQL service.

4. A service specification according to claim 1, wherein said service specification is a PROC specification specifying a PROC service.

5. A service specification according to claim 1, wherein said service specification is a CRUD specification specifying a CRUD service.

6. A service engine for executing service specification.

7. A service engine according to claim 6, wherein said service engine is a query service engine for executing query specification.

8. A service engine according to claim 6, wherein said service engine is a SQL service engine for executing SQL specification.

9. A service engine according to claim 6, wherein said service engine is a PROC service engine for executing RPOC specification.

10. A service engine according to claim 6, wherein said service engine is a CRUD service engine for executing CRUD specification.

11. A method for providing data access service, comprising executing service specification with service engine.

12. A method according to claim 11, wherein said service specification is query specification and said service engine is query service engine.

13. A method according to claim 11, wherein said service specification is SQL specification and said service engine is SQL service engine.

14. A method according to claim 11, wherein said service specification is RPOC specification and said service engine is PROC service engine.

15. A method according to claim 11, wherein said service specification is CRUD specification and said service engine is CRUD service engine.

16. A method for designing a specification type for a data access service type.

17. A server for providing data access services, comprising:
A service repository holding a plurality of service specifications for a plurality of types of data access services; and
A plurality of service engines for executing said service specifications.

18. A server according to claim 17, wherein said server is a stand-alone server.

19. A server according to claim 17, wherein said server is a cloud platform.

20. A server according to claim 17, wherein said server is embedded inside an application.

21. A server according to claim 17, wherein server is embedded inside a database.
